(19) United States
(12) Patent Application Publication
(10) Pub. No.: US 2002/0184105 A1
(43) Pub. Date: Dec. 5, 2002

(54) Commodity usage tracking and replenishment apparatus and method

(76) Inventors: Andrew J. Czuchry JR., Auburn, GA (US); William Florence, Bogart, GA (US)

Correspondence Address: CARL M. DAVIS II, BAKER , DONELSON, BEARMAN & CALDWELL, 5 CONCOURSE PARKWAY, SUITE 900, ATLANTA, GA, 30328, US

(21) Appl. No.: 09/872,644

(22) Filed: Jun. 1, 2001

(51) Int. Cl. G06F 17/60

(52) U.S. Cl. 705/26; 705/29

(57) ABSTRACT

A commodity goods usage tracking and replenishment apparatus, in which a central server has a database of consumer profiles identifying consumers and commodity goods for usage tracking and replenishment. A messaging transceiver receives and transmits messages to the central server and is selectively operated by the central server and by the consumer. An evaluator periodically determines from the use information a remaining inventory amount of the commodity goods. Upon determining that a low inventory may exist, a re-order reminder message is communicated to the messaging transceiver of the consumer, who responds with a confirmation to purchase and receive the goods. A method of tracking and replenishing commodity goods is disclosed.

### TECHNICAL FIELD

The present invention relates to devices and methods for tracking usage of commodity goods and the replenishment of inventory of such goods by consumers.

### BACKGROUND OF THE INVENTION

In recent years, persons have become increasing busy with work, school, and family activities. Notwithstanding busy activities, certain functional activities must continue to be accomplished. Among these functional activities are the shopping activities associated with obtaining commodity products used in everyday household activities. These commodity items include soap, toothpaste, tissues, cleaners, and the like. Generally, these type of commodity goods are purchased during customary grocery shopping activities for meats and vegetables. Typically, grocery shopping involves travel to a store and spending time in the store to select and purchase the items needed.

Recently, the growth of electronic business through the world wide web has sought to reduce the time required in purchasing groceries at retail stores. One company arranges for delivery of selected grocery and related items at a time prearranged with consumers. This service transfers the picking and selecting work to someone other than the consumer. The consumer merely needs to be at home at the time prearranged for delivery. However, the consumer must still generate an order list, which is similar to preparing a written list of items to purchase during a manual grocery shopping trip. Such grocery delivery services however have not met with widespread success. One reason for this is the tendency to be unable to schedule deliveries within a day or two of the consumer requesting the groceries. It has been found that deliveries need to be scheduled several or more days away from the date that the groceries are ordered. This model, however, differs from the spontaneous way most groceries are purchased. So, many persons continue to make trips to the grocery store for fresh produce, meats, vegetables, and of course commodity products.

Accordingly, there remains a need in the art for reducing the time and labor involved in typical grocery shopping by providing tracking and replenishment of commodity goods with minimal interaction by consumers. It is to the provision of such that the present invention is primarily directed.

### SUMMARY OF THE PRESENT INVENTION

The present invention meets the need in the art by providing a commodity goods usage tracking and replenishment apparatus in which a central server includes a database of at least one consumer profile identifying a consumer and at least one commodity good for usage tracking and replenishment with use information therefor. A messaging transceiver receives and transmits messages to the central server and is selectively operated by the central server and by the consumer. An evaluator periodically determines from the use information a remaining inventory amount of the at least one commodity good. Upon determining that a low inventory for the at least one commodity good may exist, a re-order reminder message is communicated to the messaging transceiver of the consumer.

In another aspect, the present invention provides a method of tracking and replenishing commodity goods used by consumers, comprising the steps of:

(a) determining a duration between a prior order for at least one commodity goods and a current date;

(b) determining an expected inventory of the at least one commodity goods based on the duration and a usage rate for the at least one commodity goods;

(c) determining a low inventory level for the at least one commodity goods by comparing a prior order quantity therefor with the expected inventory; and

(d) communicating a reminder message to the consumer to re-order the at least one commodity goods if the low inventory level therefor is less than a pre-determined amount.

Objects, advantages, and features of the present invention will become apparent upon a reading of the following detailed description in conjunction with the drawings and the appended claims.

### BRIEF DESCRIPTION OF THE DRAWINGS

FIG. 1 depicts a schematic illustration of a commodity goods usage tracking and replenishment apparatus according to the present invention.

FIG. 2 illustrates a consumer profile used in the commodity goods usage tracking and replenishment apparatus illustrated in FIG. 1.

FIG. 3 illustrates an item reminder chart for initializing the commodity goods to track in the tracking and replenishment apparatus illustrated in FIG. 1.

FIG. 4 illustrates a reminder report communicated to a consumer using the commodity goods usage tracking and replenishment apparatus illustrated in FIG. 1.

FIG. 5 illustrates a pull report generated by the commodity goods usage tracking and replenishment apparatus illustrated in FIG. 1, for use in selecting and shipping goods to the consumer to replenish the commodity goods inventory of the consumer.

FIG. 6 illustrates a block diagram of a data record associated with a consumer in the commodity goods tracking and replenishment apparatus illustrated in FIG. 1.

### DETAILED DESCRIPTION OF THE PRESENT INVENTION

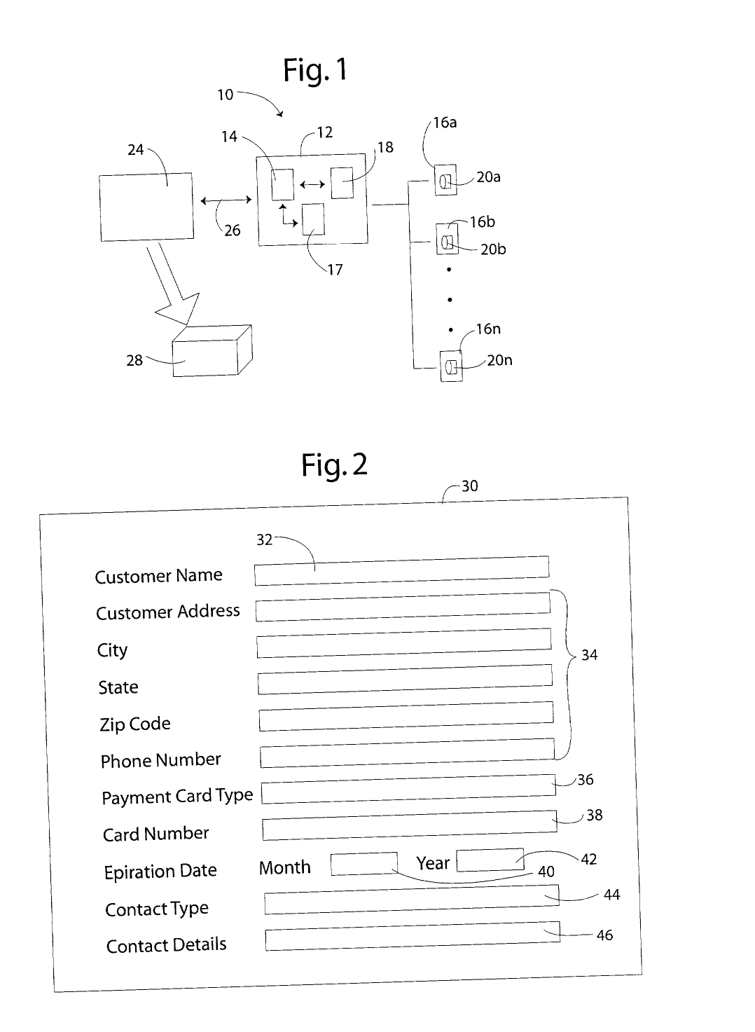

With reference to the drawings, in which like elements have like reference numerals throughout the several drawings identified above, FIG. 1 depicts a schematic illustration of a commodity goods usage tracking and replenishment apparatus 10 according to the present invention. The apparatus 10 includes a central server 12 having a data storage device 14 adapted for containing information about at least one consumer 16 and the associated commodity goods the consumer wishes to be tracked and replenished. An analyzer 17 accesses the data storage device 14 to evaluate whether goods selected by consumers 16 to be tracked, need to be replenished. The server 12 includes a communication device 18 for effecting communication between the server 12 and the consumer 16. In the illustrated embodiment, the commodity goods usage tracking and replenishing apparatus 10 includes a plurality of consumer 16a, 16b, . . . 16n. Each consumer 16 includes a communications transceiver 20. The communications transceiver receives and transmits messages by a communications pathway 22 to the communications device 18 of the server 12.

In addition, the commodity goods usage tracking and replenishment apparatus 10 includes a stock facility 24 that warehouses commodity products for purchase by and distribution to the consumers 16. The server 12 communicates with the stocking facility 24 by a communications link 26. The stocking facility 24 packages selected items for delivery to the consumer 16.

FIG. 2 is a schematic diagram of a consumer profile screen 30 used with the commodity goods usage tracking and replenishment apparatus 10. The screen 30 includes a field for the customer name 32 together with address information including street, city, state, and zip code generally 34. In the illustrated embodiment, purchases by consumer 16 are paid for at the time the goods are selected from the stocking facility 24 for shipment 28. A payment card-type 36 allows the consumer 16 to designate an account number, such as that representing a charge, debit, or “smart” card representative of a source of funds for the consumer for use in funding purchases made by the consumer. A card number field 38 includes the card number for the card-type 36. An expiration date includes a month 40 and year 42 field for use with charge cards.

The consumer 16 also provides a contact-type 44, whereby the server 12 may contact the consumer as to replenishment ordering in accordance with the present invention. The contact-type 44 in preferred embodiment is through electronic mail service from the server 12 to the consumer 16 over a telecommunications network such as the global computer web that links a number of network service providers and consumers. In an alternate embodiment, the contact-type 44 is a voice communications system. This embodiment uses wireless telecommunications devices, PDA's, and the like, operated by the consumers. It is to be appreciated that other communications mechanisms including conventional telephone, voice mail, and voice-activated inquiry and response apparatus are usable. A contact-details field 46 provides the contacting information for use by the server 12 to send messages to the consumer. For e-mail, the contact-details 46 is the consumer's electronic mail address. For voice communication, the contact-details 46 is the number of the transceiver associated with the consumer.

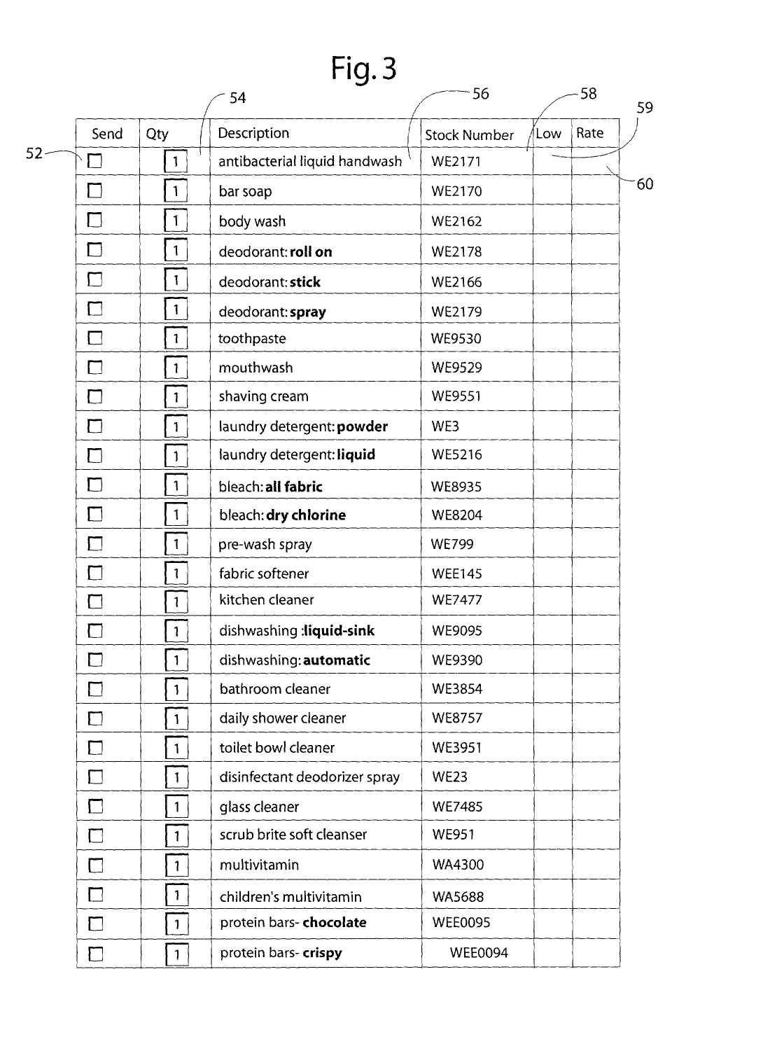

FIG. 3 illustrates an item reminder chart 50 for initializing the commodity goods to be tracked and replenished for the consumer 16 in the usage tracking and replenishment apparatus 10 illustrated in FIG. 1. The reminder chart 50 includes a field 52 for the consumer to request the selected article to be shipped. A quantity field 54 is used to designate the number of units of an article to order initially. A description field 56 describes the particular goods and a stock number field 58 identifies the internal tracking number at the stock facility 24 by which goods are selected at the stock facility 24 and packaged for shipping 28 to the consumer. As discussed below, the present invention determines possible re-supply needs due to low inventory for the particular goods 52 below a threshold (default is 1 unit). However, the consumer may also specify the minimum inventory level 59 associated with each of the goods 52 as well as the consumption rate 61. The consumption rate 61 is expressed in terms of units of the goods used per a predetermined period. In the illustrated embodiment, a number of different goods are listed; this is merely illustrative and is not intended to be a complete list. In addition, the description preferably includes brand names known to the consumer as opposed to providing a generic or non-branded product, although such could be offered. Thus, the consumer can receive the products preferred for use.

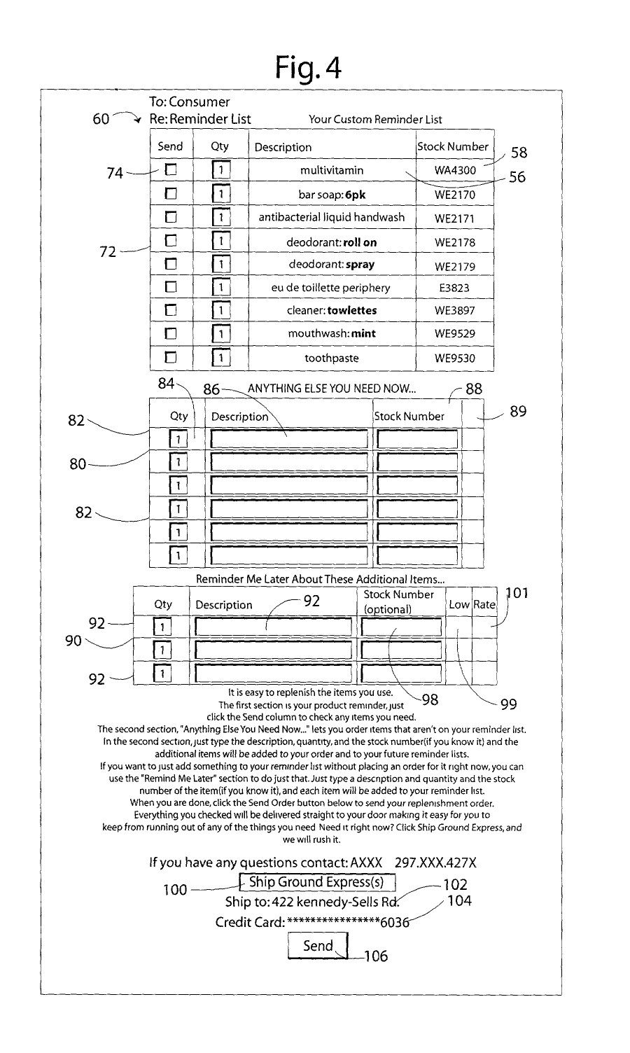

FIG. 4 illustrates a reminder report 60 communicated to a consumer using the consumer goods usage tracking and replenishment apparatus 10 illustrated in FIG. 1. The reminder report 60 includes a window or reminder list 72 that includes a list of items that the analyzer 17, associated with the server 12, has determined are possibly running low in inventory for the consumer. For each of the goods in the list, there is an associated confirmation button 74 by which the consumer confirms that the particular item is to be shipped. A quantity button 76 includes the default quantity selected by the consumer 16 on the item reminder chart 50 illustrated in FIG. 3. The reminder list 72 includes the description 56 of the goods and the stock number 58.

The consumer 16 may also list other items to purchase. A window 80 includes a plurality of item records, generally 82, in blank. Each item record 82 includes a quantity field 84, a description field 86, and a stock number 88. The window 80 also is used to revise the minimum inventory level for the particular good listed in the item record 82 by entering a new minimum inventory level 89.

The reminder report 60 also includes a window 90 for the consumer to list additional goods 52 to be reminded about later. The window 90 includes a plurality of items records, generally 92, in blank. Each record 92 includes a quantity button 94, a description 96, a stock number 98, as well as the minimum inventory level 99 and usage rate 101.

The reminder report 60 includes a request that the selected goods be shipped by ground express by marking a button 100. The shipping address 102 is displayed for confirmation as is the payment information 104. A send button 106 is selectively activated to return the reminder report 60 to the server 12 by the communications link 22.

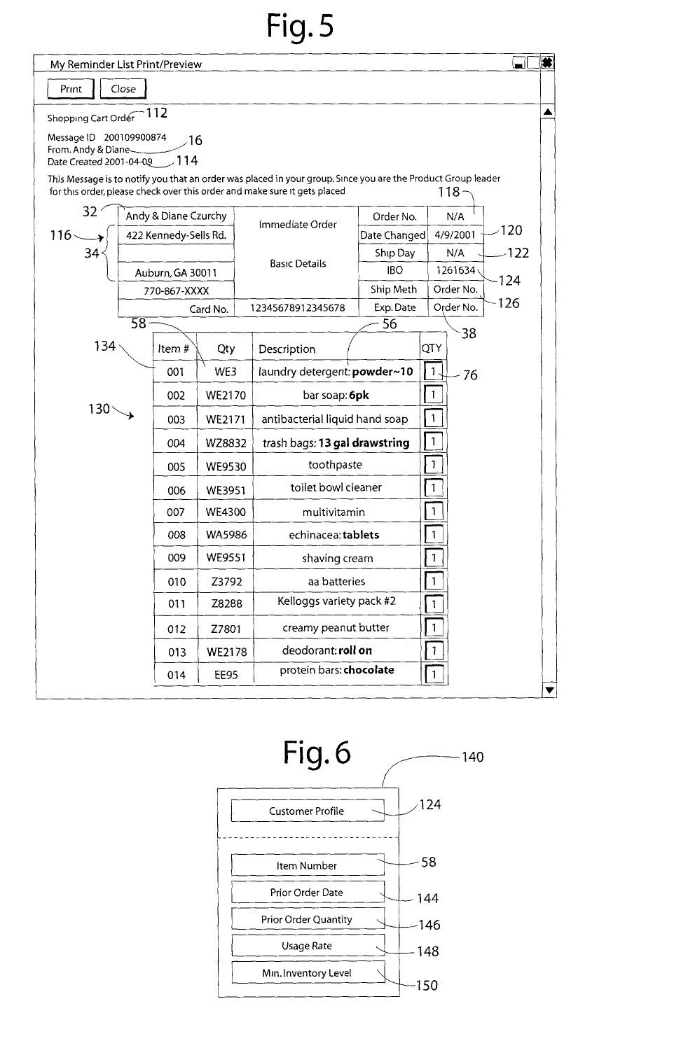

FIG. 5 illustrates a pull report 110 generated by the consumer goods usage tracking and replenishment apparatus 10 for use in selecting and shipping goods to the consumer 16 to replenish the inventory of the consumer. The report 110 includes a message identification 112 for tracking purposes. The consumer 16 is identified as is the date of the order 114. An identification portion 116 includes the consumer name 16 and address 34. An internal order number is displayed 118 together with the date 120 that the payment card-type 36 was charged for the selected goods. The pull report 110 includes a shipping date 122 and an internal customer profile number 124. The shipping instructions are provided in a field 126. The payment card number 36 and expiration date 38 are likewise displayed.

The order message 110 further includes a pull list 130 with a separate line item or pull record 132 of each item to be selected from the stocking facility 24 and shipped 28 to the consumer. The pull record 132 is from the reminder report 60. Each pull record 132 includes a sequential item number 134 that can be used for advising whether the particular item has been included in the shipment or is backordered. The record 132 also includes the stock number 58 and description 56 together with the quantity 76 included in the reminder report 60 returned by the consumer 16 to the server 12. The pull report 110 also includes the additional items records 82 from the reminder report 60.

As discussed above with respect to FIG. 4, the consumer 16 can add items to the reminder list 50 by listing these goods in the item records 92 on the reminder report 60 illustrated in FIG. 4. These items are added to the data storage device 14 with the other items to be tracked for the consumer 16. The consumer 16 can also revise the minimum inventory level by entering the stock number 88 and the new minimum inventory level 89.

FIG. 6 is a schematic block diagram of a type of data record 140 maintained in a database on the data storage device 14. The data record 140 includes the consumer profile 124 that includes the consumer name 32, address 34, payment card type 36 and number 38, expiration date with month 40 and year 42, and the contact type 44 and contact details 46. For each commodity good selected by the consumer 16 for tracking by the apparatus 10, the database includes the item number 58, a prior order date 144, a prior order quantity 146, a usage rate 148, and the minimum inventory level 150. The minimum inventory level 150 corresponds to the value for the minimum inventory level 59 entered by the consumer 16 in the initial order list shown in FIG. 3. Likewise, if the consumer entered the usage rate 61, that value is provided to the usage rate field 148.

The commodity goods tracking and replenishment apparatus 10 operates by first initially establishing the customer profile 142 information. With reference to FIG. 2, the customer name 32 and address information 34 is entered together with the appropriate payment type 36 and respective card number 38. The contact information, including the contact-type 44 and contact-details 46, are likewise entered into the system. This creates the consumer profile 142 used by the system for contacting the customer, attending to payments for transactions, and communicating information between the database 14 and the consumer 16.

With reference to FIG. 3, the consumer 16 also reviews a global item reminder list 50 to select items for tracking and replenishment. The consumer 16 checks the blocks 52 for the respective goods and changes the quantity 54 as appropriate for ordering. The minimum inventory level 59 and usage rate 61 are provided. In the illustrated embodiment, the minimum inventory level defaults to one unit of inventory. The initial order is submitted. The data storage device 14 is loaded with the consumer profile 124 and the information about the goods selected by the consumer for tracking. With reference to FIG. 6, the data records 140 is established. The initial order date is set in the prior order date 144, with the quantity ordered 146 the usage rate 148, and the minimum inventory level 150, for each of the goods selected. With respect to FIG. 5, the pull report 110 is generated. The pull report 110 is a picking list used by personnel in the warehouse facility 24 for selecting the goods, and packaging and shipping 28 the goods to the consumer 16.

After a predetermined period, the apparatus generates the reminder report 60 illustrated in FIG. 4. Generally, the apparatus 10 evaluates the projected low inventory on a daily basis for each consumer, although this can be set for another duration. The analyzer 17 accesses the data storage device 14 to evaluate whether goods selected by the consumer 16 need to be replenished. This is accomplished by dividing the prior order quantity 146 by the duration between the prior order date 144 and the date of the evaluation. If the quotient is less than the minimum inventory level 150 for the particular item number 58, the particular item is included in the reminder report 60 illustrated in FIG. 4.

The reminder report 60 is sent to advise the consumer 16 of a possible low inventory level for the goods 58 included on the reminder report 60. The response by the consumer provides information for determining consumption rates of the commodity goods listed by the consumer 16 for tracking by the apparatus 10. The consumer 16 receives the reminder report 60 and marks, for each item needed, the respective block 74 to order the particular goods. The quantity 76 is changed by the consumer 16 as necessary. The reminder report 60 is then returned to the server 12 by the communications link 22. In a preferred embodiment, the reminder report 60 is sent to the consumer 16 by conventional electronic mail on the world wide web. The reminder report 60 is returned by replying to this message through the electronic mail service used by the consumer 16.

The apparatus 10 is gainfully used in other communication environments as well. For example, voicemail apparatus, voice inquiry and response systems, wireless communications, telephone, PDA, conventional telephone, cable communication, and other interactive, two-way communications mechanisms, can be used.

Upon return of the reminder report 60 by the consumer, the apparatus 10 generates the pull report 110 for picking and shipping the requested goods. The apparatus 10 determines a new consumption rate for the particular goods. This is accomplished by dividing the quantity 76 ordered by the duration between the prior order date 144 and the date of the current order. The date of the current order is placed in the field for the prior order date 144. The quantity 76 is placed in the prior order quantity field 146. The computed usage rate is placed in the usage rate field 148. Thereafter, the apparatus 10 tracks the expected inventory based on the usage rate 148. When the inventory for the goods falls to the minimum inventory level 150 for the particular goods 52, the description 56 of the goods is included on a subsequent reminder report 60.

The tracking and replenishing apparatus 10 accordingly provides benefits to the consumers 16 in replenishing the common household commodity goods used by the consumers with minimal effort. The apparatus 10 automatically and routinely determines whether a low inventory level may exist for the commodity goods. For each such low inventory level, the apparatus 10 communicates a reminder message to the consumer 16 that the commodity good is in need of replenishment. The consumer 16 reviews the reminder list and indicates in a reply message approval for shipping selected ones of the commodity goods. The consumer 16 thereby orders the commodity goods without having to search, such as a web site on the world wide web or having to visit a retail store. The reminder report 60 is personalized for the particular consumer 16. First, by the consumer selecting the particular commodity goods to be tracked, and second, by the evaluator listing in the reminder report 60 only those commodity goods determined to have low inventory levels.

The reminder report 60 is communicated by electronic mail, by voice messaging, text communication with a transceiver device adapted to receive and display such messages for example interactive television and cable communications, and other wireless and non-wireless communication media. The apparatus 10 provides for convenient response by the consumer whereby the low inventory commodity goods are readily re-ordered and shipped to the consumer.

It is to be appreciated that while the above description refers to commodity goods, any type of inventoried consumable good and its replenishment is encompassed by the invention disclosed herein. For example, commercial establishments, restaurants, food purveyors, pharmacies, and other entities will likewise find the present invention gainfully provides just-in-time re-supply of inventory in a timely manner. Other environments of useful application generally for the present invention include those in which an inventory of a product is depleted or removed from inventory for use, with the inventory periodically replenished.

While the commodity goods tracking and replenishing apparatus has been described in detail with particular references to the preferred embodiments thereof, it should be understood that many modifications, additions and deletions, in addition to those expressly recited, may be made thereto without departure from the spirit and scope of the invention as set forth in the following claims.

What is claimed is:

1. A commodity goods usage tracking and replenishment apparatus, comprising:
a central server including a database of at least one consumer profile identifying a consumer and at least one commodity good for usage tracking and replenishment with use information therefor;
a messaging transceiver for receiving and transmitting messages to the central server and selectively operated by the central server and by the consumer; and
an evaluator for periodically determining from the use information a remaining inventory amount of the at least one commodity good, such that upon determining a low inventory for the at least one commodity good may exist, a re-order reminder message is communicated to the messaging transceiver of the consumer.

2. The commodity goods apparatus recited in claim 1, wherein the messaging transceiver comprises an electronic mail device.

3. The commodity goods apparatus as recited in claim 1, wherein the messaging transceiver is a PDA device.

4. The commodity goods apparatus as recited in claim 1, wherein the use information includes for each commodity good to be tracked a prior order number date, a prior order number quantity, and a usage rate, whereby the evaluator can determine whether the low inventory may exist.

5. The commodity goods apparatus as recited in claim 1, further comprising a warehouse for obtaining the commodity goods for shipment to the consumer responding to the re-order reminder message.

6. A method of tracking and replenishing commodity goods used by consumers, comprising the steps of:
(a) determining a duration between a prior order for at least one commodity goods and a current date;
(b) determining an expected inventory of the at least one commodity goods based on the duration and a usage rate for the at least one commodity goods;
(c) determining a low inventory level for the at least one commodity goods by comparing a prior order quantity therefor with the expected inventory; and
(d) communicating a reminder message to the consumer to re-order the at least one commodity goods if the low inventory level therefor is less than a pre-determined amount.

7. The method of tracking and replenishing as recited in claim 6, further comprising the step of the consumer reviewing the reminder message and replying with authorization to ship the at least one commodity goods listed therein.

8. The method of tracking and replenishing as recited in claim 7, wherein the consumer changes the amount of the at least one commodity goods to re-order prior to replying.

9. The method of tracking and replenishing as recited in claim 6, further comprising the step of shipping a quantity of the at least one commodity goods included in the reply message to the consumer.

10. The method of tracking and replenishing as recited in claim 6, further comprising the step of creating an initial group of the at least one commodity goods by selecting from a list of all available commodity goods.
